(19) United States
(12) Patent Application Publication
(10) Pub. No.: US 2008/0080351 A1
(43) Pub. Date: Apr. 3, 2008

(54) DISK AND MANUFACTURING METHOD AND OPTICAL PATTERNING METHOD THEREOF

(75) Inventors: Chen Peng, Taipei City (TW); Fung-Hsu Wu, Taoyuan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: DAXON TECHNOLOGY INC., Taoyuan County (TW)

(21) Appl. No.: 11/865,752

(22) Filed: Oct. 2, 2007

(30) Foreign Application Priority Data
Oct. 3, 2006 (TW) 95136774

(51) Int. Cl. G11B 3/74

(52) U.S. Cl. 369/94

(57) ABSTRACT

A disk and a manufacturing method and an optical patterning method thereof are provided. The disk has a recording surface for recording data and an opposite non-recording surface for printing label. The disk at least includes a light-sensitive layer and a thermo-sensitive layer. The light-sensitive layer disposed near the non-recording surface. After receiving laser light, the light-sensitive layer transforms the laser light into thermal energy. The thermo-sensitive layer is disposed near the light-sensitive layer. The color of the thermo-sensitive layer can form an optical pattern after receiving the thermal energy.

This application claims the benefit of Taiwan application Serial No. 95136774, filed Oct. 3, 2006, the subject matter of which is incorporated herein by reference.

### BACKGROUND OF THE INVENTION

1. Field of the Invention

Generally, this present invention relates to a disk, a manufacturing method and an optical patterning method thereof, which are more particularly to a disk including a light-sensitive layer and a thermo-sensitive layer for forming an optical pattern at the disk, and a manufacturing method and an optical patterning method thereof.

2. Description of the Related Art

Among all kinds of digital storage media, disks have advantages including large storage capacity, feasible portability and long-term storage. Also, data is not easy to lose when stored in the disk. Therefore, the disks are widely used in people's daily lives. Digital data are stored in the tracks of the disk. When a user is willing to know what is stored in a disk, the user has to put the disk in an optical disk drive and view the contents of the disk through a screen. Otherwise, the user cannot know what is stored in the disk from the appearance of the disk.

Please referring to FIG. 1, a conventional disk 500 is illustrated in FIG. 1. A label 510 is adhered to a non-recording surface 500b of the disk 500 to indicate what is stored in the disk 500. Therefore, a user knows what content of the disk 500 is about from the label 510. However, this method includes following disadvantages.

First of all, when the label 510 is attached to the non-recording surface 500b, it is not easy to stick the label 510 flatly to the disk 500. The disk 500 does not look neat when the label 510 is not adhered to the non-recording surface 500b tidily.

Secondly, after digital data is written into the disk 500, the user has to get a label 510 before marking any information on the label 510. However, the label 510 is not existed everywhere. When there is no label around, the user can not label the disk 500.

Thirdly, the label 510 has a certain thickness. When the label 510 is pasted to the disk 500, the thickness of the disk 500 and the label 510 may be too large. As a result, the disk 500 may not move normally in the optical disk drive. This problem occurs especially when the label 510 is not adhered flatly.

Please referring to FIG. 2, another conventional disk 600 is illustrated in FIG. 2. A user writes with a marker directly on the non-recording surface 600b of the disk 600. However, this method has following disadvantages.

First of all, each person has different handwriting. Sometimes people cannot recognize other's scratchy handwriting, so they may not know what is stored in the disk 600.

Secondly, the user has to use a marker to write on the disk 600. Common pens, such as ball pens, pencils, or highlighters, are not suitable for the disk 600. Therefore, it is very inconvenient to label the disk 600 when the user does not have a marker.

Thirdly, when a marker is used to write on the non-recording surface 600b of the disk 600, the ink of the marker usually peels off and pollutes the optical pick-up head of the optical disk drive. As a result, the optical disk drive may be damaged.

Please referring to FIGS. 3A˜3B, another conventional disk 700 is illustrated in FIGS. 3A˜3B. Nowadays, an optical patternable disk 700 is available in the market. As shown in FIG. 3A, the disk 700 has a recording surface 700a and a non-recording surface 700b. The disk 700 includes a substrate 710, a record layer 720, a reflection layer 730, a protection layer 740 and an optical patterning layer 750. The optical patterning layer 750 is directly by screen-printing or spin-coating on the non-recording surface 700b. Words and patterns are formed by focused of laser light L3 emitted by an optical pick-up head 790 of the optical disk drive. However, there are disadvantages of this disk 700 listed as following:

First of all, the optical patterning layer 750 is directly by screen-printing or spin coating on the non-recording surface 700b. However, the surface of the optical patterning layer 750 is so rough and with really low reflection index that the laser light L3 can scatter or cannot be focused after emitted into the optical patterning layer 750.

Secondly, when a pregroove (not shown in FIG. 3A) with address information is formed under the optical patterning layer 750, the address information can not be read effectively due to the low reflection index of the optical patterning layer 750. Therefore, another address information track 760 is needed on the inner ring of the disk 700, so that the optical pick-up head 790 can be tracking locations precisely when patterning.

Thirdly, as stated above, because the surface of the optical patterning layer 750 is really rough, and the address information track 760 is formed at the inner ring of the disk 700, when patterning the disk 700, not only the laser light L3 is hard to focused but also the optical pick-up head 790 has to move back and forth between the address information track 760 on the inner ring and the desired location to be patterned. That's why the optical patterning speed is really slow. Generally speaking, it takes more than twenty minutes to finish patterning one disk 700.

Please referring to FIGS. 4A˜4B, another conventional disk 800 is illustrated in FIGS. 4A˜4B. As shown in FIG. 4A, the disk 800 has a recording surface 800a and a non-recording surface 800b. The disk 800 includes a substrate 810, a record layer 820, a reflection layer 830, an adhesion layer 840, a reflection layer 850, an optical patterning layer 860 and another substrate 870. The optical patterning layer 860 is formed in the disk 800 through spin coating. There is a pregroove G4 between the optical patterning layer 860 and the substrate 870. The optical pick-up head 890 emits laser light L4 which passes through the substrate 870, the optical patterning layer 860 and the pregroove G4 at the non-recording surface 800b. Later, the laser light L4 is reflected by the reflection layer 850, so that the address information of the pregroove G4 is transmitted back to the optical pick-up head 890. Accordingly, the optical pick-up head 890 is tracking locations precisely when patterned. Meanwhile, the laser light L4 patterns the optical patterning layer 860 directly. However, there are disadvantages of disk 800 listed as following:

First of all, the optical patterning layer 860 has to be a really thin film with a certain transparency because the laser light L4 has to pass through the optical patterning layer 860 to reach the reflection layer 850 for reflecting back the address information. Therefore, the optical patterning material layer 860 must has a pretty strict limitation with its thickness.

Secondly, when the optical patterning layer 860 is not thick enough, the optical pattern is not clear, and the contrast ratio is low.

Therefore, it is very important to develop a disk to solve the above problems.

### SUMMARY OF THE INVENTION

The invention is directed to a disk and a manufacturing method and an optical patterning method thereof. A light-sensitive layer is for generating thermal energy accordingly after receiving laser light. An optical pattern is formed by thermo-sensitive layer which motivated by transmitted thermal energy. Therefore, the disk and the manufacturing method and the optical patterning method thereof of the present invention have following advantages. The disk is flat and neat. It looks elegant to have patterns on the disk. The optical disk drive won't be polluted by the ink. The contrast ratio of the optical pattern is good. The optical patterning speed is fast. The optical pattern can be enhanced on some designs.

According to the present invention, a disk having a recording surface and a non-recording surface opposite thereto is provided. The recording surface is for recording data. The disk at least includes a light-sensitive layer and a thermo-sensitive layer. The light-sensitive layer is disposed near the non-recording surface. The light-sensitive layer is for receiving laser light and then transforming the laser light into thermal energy. The thermo-sensitive layer is disposed near the light-sensitive layer. After receiving the thermal energy, the color of the thermo-sensitive layer is changed to form an optical pattern.

According to the present invention, a manufacturing method of a disk is provided. The method at least includes following steps. First of all, a substrate having a non-recording surface is provided. Next, a light-sensitive layer is formed over the substrate. Then, a thermo-sensitive layer is formed over the light-sensitive layer.

According to the present invention, an optical patterning method of a disk is provided. The method at least includes following steps. First, a disk at least including a light-sensitive layer and a thermo-sensitive layer is provided. Next, laser light is focused on the light-sensitive layer, so that the laser light is transformed into thermal energy. Then, the thermal energy is transmitted to the thermo-sensitive layer, so that the color of the thermo-sensitive layer is changed when patterning.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) illustrates a conventional disk;

FIG. 2 (Prior Art) illustrates another conventional disk;

FIGS. 3A˜3B (Prior Art) show another conventional disk;

FIGS. 4A˜4B (Prior Art) show another conventional disk;

FIG. 5A illustrates a disk according to a first embodiment of the present invention;

FIG. 5B illustrates the appearance of the disk in FIG. 5A;

FIG. 6 is a flow chart of an optical patterning method of the disk in FIG. 5A;

FIG. 7 is a flow chart showing a manufacturing method of a disk according to the present invention;

FIGS. 8A˜8G illustrate every individual step in FIG. 7;

FIG. 9 illustrates a disk according to a second embodiment of the present invention;

FIG. 10 illustrates a disk according to a third embodiment of the present invention; and

FIG. 11 illustrates a disk according to a fourth embodiment of the present invention.

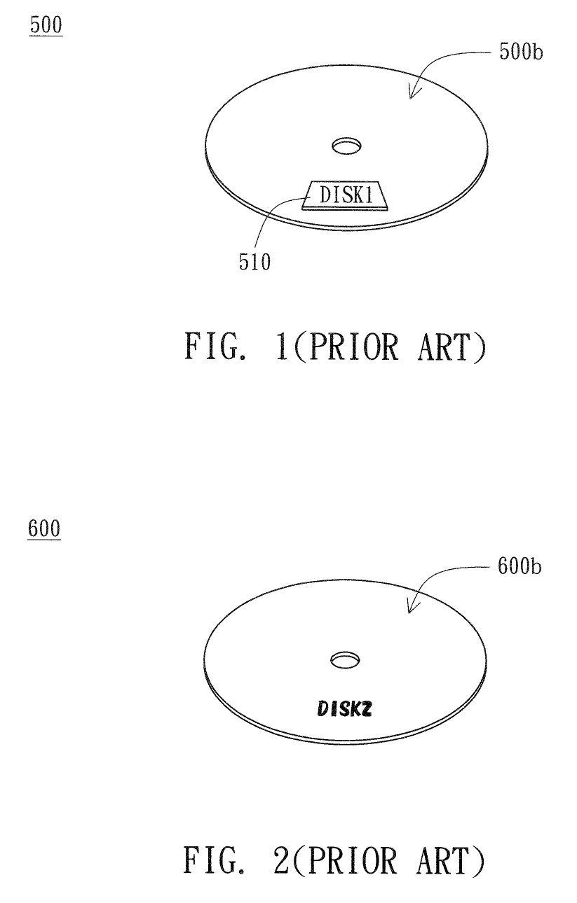

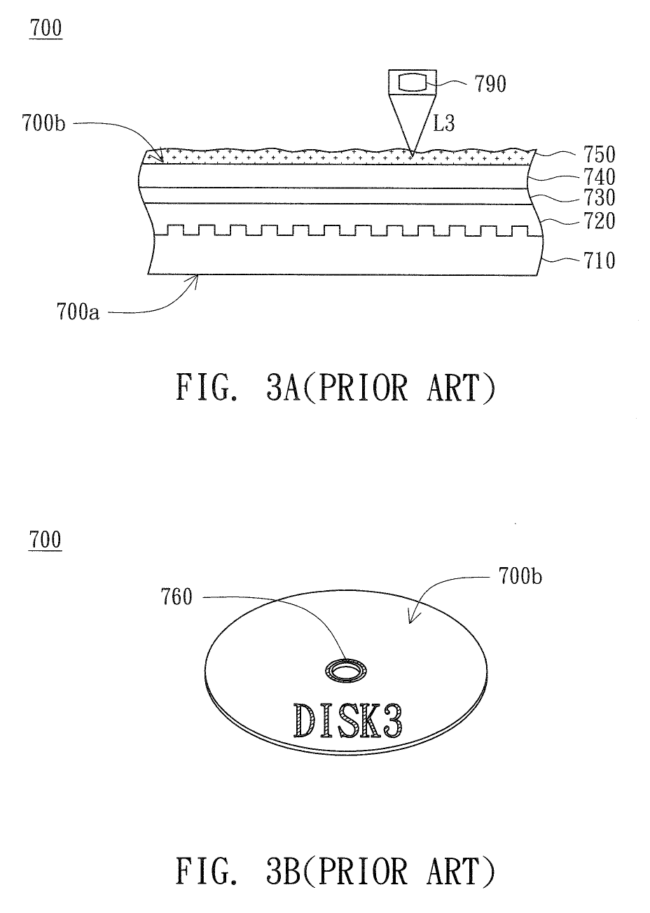

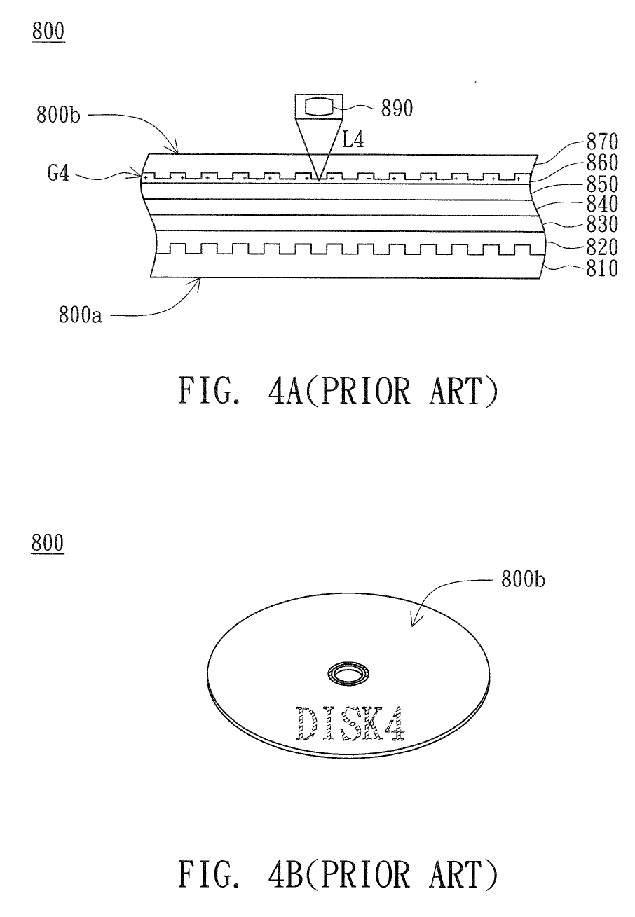

### DETAILED DESCRIPTION OF THE INVENTION

### First Embodiment

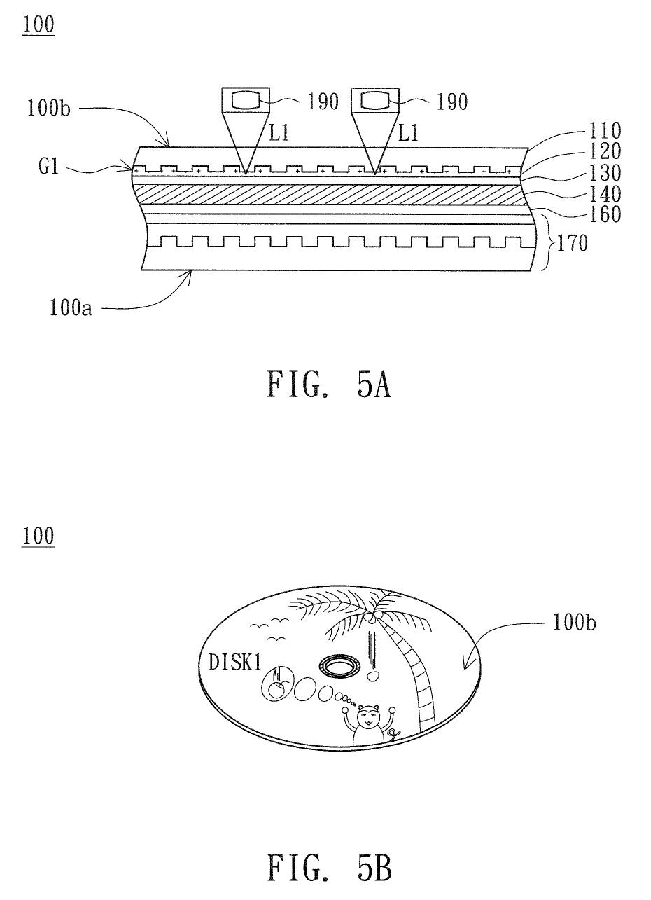

Please referring to FIG. 5A, a disk 100 is showed according to a first embodiment of the present invention. The disk 100 has a recording surface 100a and a non-recording surface 100b opposite thereto. The recording surface 100a is for recording data. The disk 100 at least includes a light-sensitive layer 120 and a thermo-sensitive layer 140. The light-sensitive layer 120 is disposed near the non-recording surface 100b. After the light-sensitive layer 120 receives a laser light L1, the light-sensitive layer 120 transforms the laser light L1 into thermal energy. The thermo-sensitive layer 140 is disposed near the light-sensitive layer 120. After the thermo-sensitive layer 140 receives the thermal energy, the color of the thermo-sensitive layer 140 is changed accordingly to form an optical pattern. An optical pattern is formed quickly and effectively on the disk 100 of the present invention after the light-sensitive layer 120 receives the laser light L1. The structure of the disk 100 and an optical patterning method thereof according to the present invention are illustrated as follow with reference to the accompanying drawings.

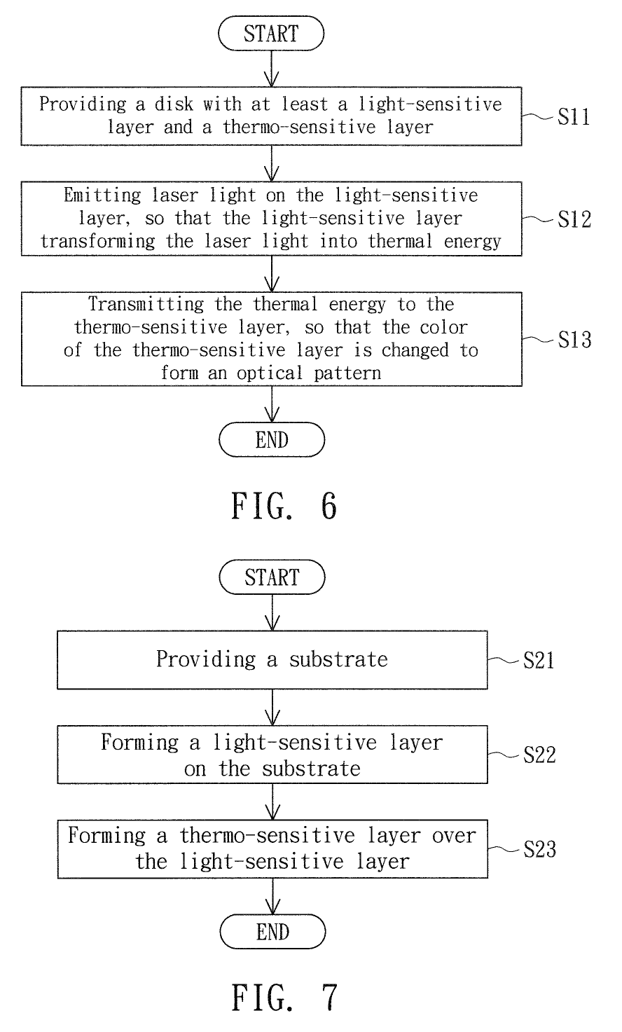

Please refer to FIG. 5A, FIG. 5B and FIG. 6 together. FIG. 5B illustrates the appearance of the disk 100 of FIG. 5A. FIG. 6 is a flow chart of the optical patterning method of the disk 100 in FIG. 5A. First, in the step S11, a disk 100 with at least a light-sensitive layer 120 and a thermo-sensitive layer 140 is provided. As shown in FIG. 5A, the disk 100 further includes a substrate 110, a reflection layer 130, an adhesive layer 160 and a record multilayer 170. The substrate 110, the light-sensitive layer 120, the reflection layer 130, the thermo-sensitive layer 140, the adhesion layer 160 and the record multilayer 170 are formed from top to bottom. The up surface of the substrate 110 is the non-recording surface 100b. The bottom surface of the record multilayer 170 is the recording surface 100a. The adhesion layer 160 is for adhering the record multilayer 170 and the structure above the adhesion layer 160. A pregroove G1 with address information is further formed between the substrate 110 and the light-sensitive layer 120. In order to describe the optical patterning method and manufacturing method of the disk 100 clearly, the optical method of the disk 100 is going to be described first, and the manufacturing method of the disk 100 is going to be described later.

Next, in the step S12 shown in FIG. 6, in an optical disk drive, an optical pick-up head 190 emits the laser light L1 on the light-sensitive layer 120, so that the light-sensitive layer 120 transforms the laser light L1 into thermal energy. After passing through the substrate 110, the pregroove G1 and the light-sensitive layer 120, the laser light L1 is reflected by the reflection layer 130 back to the optical pick-up head 190. In this step, the optical pick-up head 190 is tracking and positioned to a location to be patterned according to the address information of the pregroove G1. In the meanwhile, the laser light L1 is transformed into thermal energy at the light-sensitive layer 120.

Afterwards, in the step S13 shown in FIG. 6, the thermal energy is transmitted to the thermo-sensitive layer 140 from the light-sensitive layer 120. After the thermo-sensitive layer 140 receives the thermal energy, the color of the thermo-sensitive layer 140 is changed for forming an optical pattern, as shown in FIG. 5B. Wherein the color changes of the thermo-sensitive layer 140 are different depending on the material of the thermo-sensitive layer 140.

Preferably, in the step S12, an intensity and an emitting period of the laser light L1 is controllable, so that the light-sensitive layer 120 is able to generate different amounts of thermal energy. Furthermore, in the step S13, the thermo-sensitive layer 140 changes its color in different scales according to the amount of the thermal energy. Therefore, the optical pattern of the disk 100 is colorful.

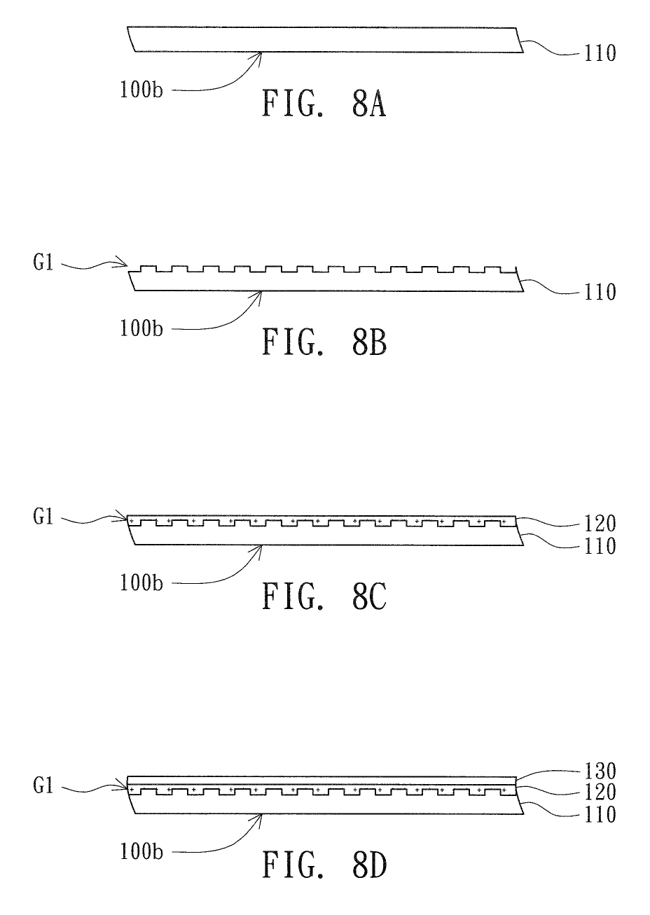

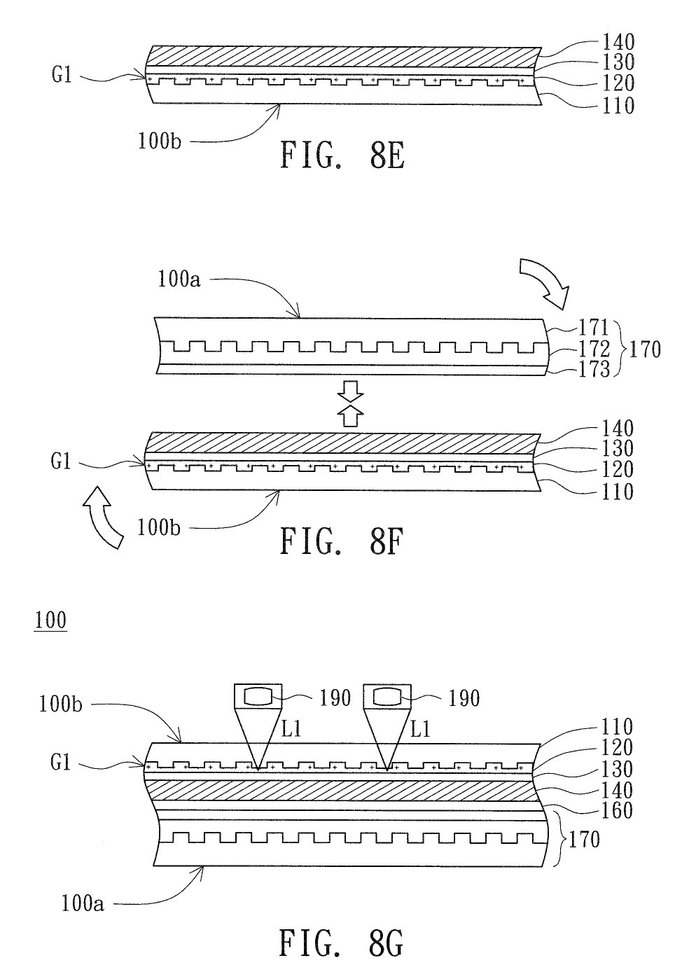

Please refer to FIG. 7 and FIGS. 8A˜8G to illustrate the manufacturing method of the disk 100. FIG. 7 is a flow chart showing the manufacturing method of the disk according to the present invention. FIGS. 8A˜8G illustrate every individual step in FIG. 7.

First, in the step S21, the substrate 110 is provided as shown in FIG. 8A. The substrate 110 has a non-recording surface 100b. The substrate 110 is transparent, so that the laser light L1 is able to transmit to the inner part of the disk 100 (the laser light L1 and the disk 100 are shown in FIG. 5A).

Next, as shown in FIG. 8B, the pregroove G1 is formed on the substrate 110 with address information on it. The optical pick-up head 190 (the optical pick-up head 190 is shown in FIG. 5A) is tracking locations precisely when patterning by the address information of the pregroove G1.

Then, in the step S22, the light-sensitive layer 120 is formed on the substrate 110 as shown in FIG. 8C. The light-sensitive layer 120 is made of a material which is able to generate thermal energy after receiving the laser light L1. Generally speaking, the light-sensitive layer 120 receives the laser light L1 with a specific wavelength and then transforms into thermal energy accordingly. For example, the laser light L1 has 780 nm wavelength, 635 nm wavelength, 650 nm wavelength or 405 nm wavelength. The laser light with 780 nm wavelength is used in the CD optical pick-up head and the laser light with 635 nm wavelength, 650 nm wavelength or 405 nm wavelength is used in the DVD optical pick-up head. The light-sensitive layer 120 can be made of different materials depending on the needs. For example, the light-sensitive layer 120 is made of an athraquinone material, a cyanine material, an indigo material, an azo material or the combination thereof. After the laser light L1 with a specific wavelength is emitted to these materials, a certain amount of thermal energy is generated.

Because the light-sensitive layer 120 is not disposed on/outside (FIG. 8D) the non-recording surface 100b, the non-recording surface 100b is flat. Therefore, when the laser light L1 passes through the non-recording surface 100b in the above-described optical patterning process, the scattering or un-focused problems do not occur.

Furthermore, in the optical patterning process, the thermal energy is generated when the laser light L1 is emitted into the light-sensitive layer 120, and the address information is reflected back after the laser light L1 reaches the reflection layer 130. Therefore, the light-sensitive layer 120 is disposed on a side of the reflection layer 130, and the side is close to the non-recording surface 100b. The light-sensitive layer 120 has to be thin enough to have a certain level of transparency. Otherwise, the laser light L1 can not pass through the light-sensitive layer 120.

Preferably, the light-sensitive layer 120, formed on the substrate 110 through spin coating, is a thin film with high transparency. In the present embodiment, the thickness of the light-sensitive layer 120 is substantially between 20 nm and 200 nm.

Later, as shown in FIG. 8D, the reflection layer 130 is formed on the light-sensitive layer 120. The reflection layer 130 with high reflection index is made of metal, such as gold, silver, copper, aluminum or the combination thereof. Or, the reflection layer 130 can be made of metal with a low melting point, such as tin or tin alloy. In the present embodiment, the reflection layer 130 is made of metal with high reflection ratio as an example. In a third embodiment which is described later, the reflection layer 130 is made of metal with a low melting point as an example. In the above-described optical patterning process, the laser light L1 is reflected by the reflection layer 130, so that's how the address information is read by the optical pick-up head 190. Due to a flat non-recording surface 100b of the substrate 110 and a thin light-sensitive layer 120, the laser light L1 does not scatter when passing through the substrate 110, the light-sensitive layer 120 and the pregroove G1. The address information is directly transmitted back through the reflection layer 130. There is no need to form another address information track at the inner ring.

In the step S23, also as shown in FIG. 8E, a thermo-sensitive layer 140 is formed over the light-sensitive layer 120. In other words, the thermo-sensitive layer 140 is formed over the reflection layer 130. The thermo-sensitive layer 140 is preferably formed through screen printing or spin coating.

When patterning, the laser light L1 does not pass through the thermo-sensitive layer 140, therefore, the thickness of the thermo-sensitive layer 140 does not affect the location tracking of the optical pick-up head 190. Furthermore, the thicker the thermo-sensitive layer 140 is, the better contrast ratio the optical pattern performs. Generally speaking, compare with spin coating manufactures, the thermo-sensitive layer 140 is thicker when screen printing manufactures. In the present embodiment, the thermo-sensitive layer 140 is manufactured through screen printing, and the thickness of the thermo-sensitive layer 140 is between 0.2 μm and 30 μm. Therefore, a better contrast ratio can be obtained.

The material of the thermo-sensitive layer 140 is not restricted to an organic material or an inorganic material. Furthermore, the material of the thermo-sensitive layer 140 is not restricted to a reversible thermochromism material or an irreversible thermochromism material. Preferably, the thermo-sensitive layer 140 is made of an organic irreversible thermochromism material to obtain better color-changing effects. However, the thermo-sensitive layer 140 can be made of different materials according to the demands. For example, the thermo-sensitive layer 140 is made of crystal violet lactone (CVL) or 4-hydroxy-4′-isopropoxy diphenyl sulphone. There are many similar materials like these two. As long as the thermo-sensitive layer 140 is made of material which can change color according to thermal energy, the present invention encompasses in the mentioned above modification.

Next, as shown in FIG. 8F, a record multilayer 170 is for recording digital data. The record multi-layer 170 at least includes a substrate 171, a record layer 172 and a reflection layer 173.

Then, as shown in FIG. 8G, the multilayer 170 and the structure over an adhesion layer 160 are stuck together by the adhesion layer 160. The disk 100 of the present embodiment is formed completely in this step.

Using the manufacturing method of the disk according to the present embodiment, the disk 100 is formed. An optical pattern with better effects is formed on the disk 100 according to the above-described optical patterning method.

### Second Embodiment

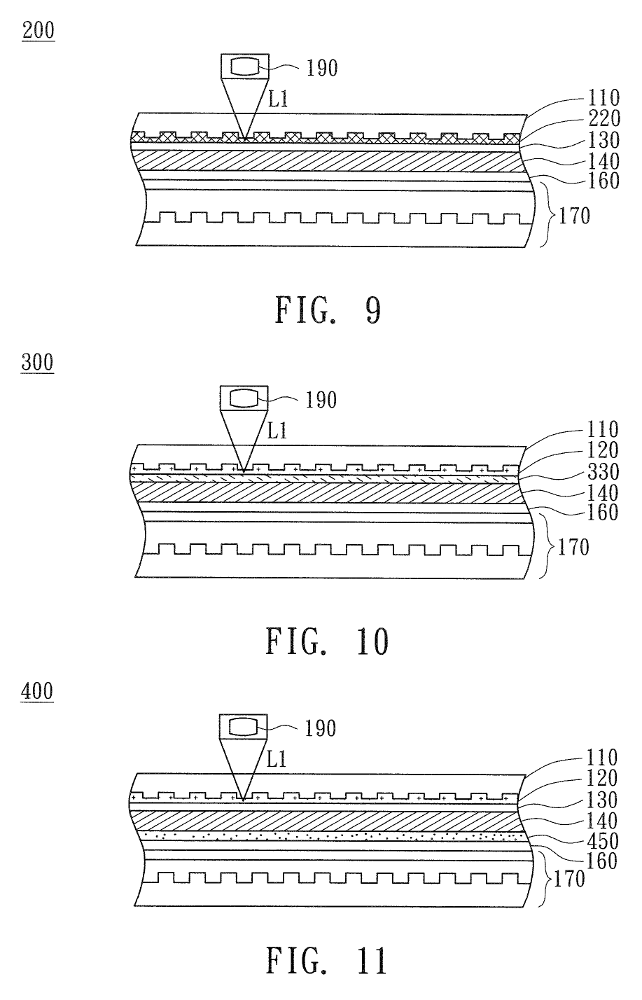

A difference between a second embodiment, including a disk 200 and a manufacturing method and an optical patterning method thereof, and the first embodiment, the disk 100 and the manufacturing method and optical patterning method thereof, is the design of the light-sensitive layer 220. The same parts of these two embodiments are not described repeatedly. Please referring to FIG. 9, the disk 200 according to the second embodiment of the present invention is illustrated in FIG. 9. When patterning of the present embodiment, the light-sensitive layer 220 transforms the laser light L1 into thermal energy. Furthermore, the color of the light-sensitive layer 220 is changed after the light-sensitive layer 220 receives the laser light L1. The light-sensitive layer 220 and the thermo-sensitive layer 140 present a clearer optical pattern.

Preferably, colors that light-sensitive layer 220 changes into differ from colors that the thermo-sensitive layer 140 changes into. A more colorful optical pattern can be reach due to the combination of both the colors of the light-sensitive layer 220 and the colors of the thermo-sensitive layer 140.

### Third Embodiment

A difference between a present embodiment, including a disk 300 and a manufacturing method and an optical patterning method thereof, and the first embodiment, the disk 100 and the manufacturing method and the optical patterning method thereof, is the design of the reflection layer 330. The same parts of these two embodiments are not described repeatedly. Please referring to FIG. 10, the disk 300 according to the third embodiment of the present invention is illustrated in FIG. 10. The reflection layer 330 is made of metal with a low melting point, such as tin or tin alloy. After the optical-patterning of the disk 300 is done, the optical pick-up head 190 does not need to perform any further steps on the non-recording surface 100b. Therefore, some structure damage is endurable in the optical patterning process of the disk 300. In the present embodiment, cuts are made by melting and deformation after thermo energy received on the reflective layer 330. Users can observe the cuts from the non-recording surface 100b. Therefore, the cuts generated on the reflection layer 330 and the color-changing of the thermo-sensitive layer 140 together present a clearer optical pattern.

### Fourth Embodiment

A difference between a present embodiment, including a disk 400 and a manufacturing method and an optical patterning method thereof, and the first embodiment, and the disk 100 and the manufacturing method and optical patterning method thereof, is the design of a foam layer 450. The same parts of these two embodiments are not described repeatedly. Please referring to FIG. 11, the disk 400 of the fourth embodiment of the present invention is illustrated in FIG. 11. The disk 400 of the present embodiment further includes the foam layer 450 disposed close to the thermo-sensitive layer 140. The foam layer 450 foams after receiving thermal energy. For example, the foam layer 450 generates gas or bloats after receiving thermal energy. The foam layer 450 is preferably made of sodium bicarbonate (NaHCO₃), ammonium carbonate, ammonium bicarbonate, nitrite, perchlorate, an azo-based material, diazonium or the combination thereof. The pattern generated through foaming can be observed from the non-recording surface 100b. Therefore, a clearer optical-pattern is formed by the foam layer 450 and the thermo-sensitive layer 140 together.

In the disk and the manufacturing method and the optical patterning method thereof according to the above embodiments of the present invention, the light-sensitive layer receives the laser light and then generates thermal energy. The thermal energy is transmitted to the thermo-sensitive layer to form the optical pattern. Advantages of the disk and the manufacturing method and the optical patterning method thereof are listed as following:

First of all, the surface of the disk is flat and tidy. Because the optical pattern is formed on the non-recording surface directly for labeling the disk, there is no need to stick a label on the non-recording surface. This solves the problem of non-flatly-stuck label of the disk.

Secondly, the appearance of the disk looks elegant. The optical pattern is formed by the laser light of the optical pick-up head. The font is clear and easy to read. This solves the problem of hardly-recognizing-handwritings. Furthermore, the laser light is able to print a refined pattern.

Thirdly, it is very convenient to perform the optical patterning method on the disk. Users only needs to use the optical disk drive to make optical pattern the disk. There is no need to use a specific tool, such as a label or a marker.

Fourthly, the optical disk drive is not polluted by this patterning way. The inner optical patterning structure of the disk solves this ink pollution problem of optical disc.

Fifthly, the contrast ratio of the optical pattern is good. The thickness of the thermo-sensitive layer does not affect the tracking locations of the optical pick-up head. Therefore, the thermo-sensitive layer is thick enough to present a fine optical pattern with high contrast ratio.

Sixthly, the optical patterning speed is fast. The optical pick-up head is positioned to a location to be patterned at the pregroove. The laser light emitted from the optical pick-up head is focused on the light-sensitive layer accurately.

Seventhly, the optical pattern is enhanced when a color changeable light-sensitive layer, a deformable reflection layer or a foam layer works together with the thermo-sensitive layer.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A disk having a recording surface and a non-recording surface opposite thereto, the recording surface is for recording data, the disk at least comprising:
a light-sensitive layer disposed near the non-recording surface, and after the light-sensitive layer receives laser light, the light-sensitive layer transforms the laser light into thermal energy; and
a thermo-sensitive layer disposed near the light-sensitive layer, and after the thermo-sensitive layer receives the thermal energy, the color of the thermo-sensitive layer being changed to form an optical pattern.

2. The disk according to claim 1, wherein the color of the light-sensitive layer is changed after the light-sensitive layer receives the laser light, the light-sensitive layer and the thermo-sensitive layer forming the optical pattern together.

3. The disk according to claim 1, wherein the light-sensitive layer is made of an athraquinone material, a cyanine material, an indigo material, an azo material or the combination thereof.

4. The disk according to claim 1, wherein the thermo-sensitive layer is made of an organic material.

5. The disk according to claim 1, wherein the thermo-sensitive layer is made of an inorganic material.

6. The disk according to claim 1, wherein the thermo-sensitive layer is made of a reversible thermochromism material.

7. The disk according to claim 1, wherein the thermo-sensitive layer is made of an irreversible thermochromism material.

8. The disk according to claim 1, wherein the thermo-sensitive layer is made of crystal violet lactone (CVL) or 4-hydroxy-4′-isopropoxy diphenyl sulphone.

9. The disk according to claim 1 further comprising:
a foam layer disposed near the light-sensitive layer, after the foam layer receives the thermal energy, the foam layer foams, wherein the foam layer and the thermo-sensitive layer forms the optical pattern together.

10. The disk according to claim 9, wherein the foam layer is made of sodium bicarbonate (NaHCO₃), ammonium carbonate, ammonium bicarbonate, nitrite, perchlorate, an azo-based material, diazonium or the combination thereof.

11. The disk according to claim 1 further comprising:
a reflection layer disposed near the light-sensitive layer.

12. The disk according to claim 11, wherein the reflection layer is made of metal with a low melting point, after receiving the thermal energy, the reflection layer being melted and deformed.

13. The disk according to claim 12, wherein the reflection layer is made of tin or tin alloy.

14. The disk according to claim 1 further comprising:
a substrate disposed on a side of the light-sensitive layer, a pregroove formed between the substrate and the light-sensitive layer for positioning the location where the laser light is emitted to.

15. A manufacturing method of a disk, the method at least comprising:
providing a substrate;
forming a light-sensitive layer over the substrate; and
forming a thermo-sensitive layer over the light-sensitive layer.

16. The method according to claim 15, wherein the thermo-sensitive layer is formed over the light-sensitive layer through screen printing.

17. The method according to claim 15, wherein the thermo-sensitive layer is formed over the light-sensitive layer through spin coating.

18. The method according to claim 15 further comprising:
forming a foam layer over the thermo-sensitive layer.

19. The method according to claim 15 further comprising:
forming a reflection layer over the light-sensitive layer.

20. The method according to claim 15 further comprising:
forming a pregroove between the substrate and the light-sensitive layer.

21. An optical patterning method of a disk, the method at least comprising:
providing a disk at least comprising a light-sensitive layer and a thermo-sensitive layer;
emitting a laser light to the light-sensitive layer, so that the light-sensitive layer transforms the laser light into thermal energy; and
transmitting the thermal energy to the thermo-sensitive layer, so that the color of the thermo-sensitive layer is changed to form an optical pattern.

22. The method according to claim 21, wherein the color of the light-sensitive layer is changed when the laser is emitted on the light-sensitive layer, the light-sensitive layer and the thermo-sensitive layer forming the optical pattern together.

23. The method according to claim 21, wherein the disk further comprises a foam layer, the method further comprising:
transmitting the thermal energy to the foam layer, so that the foam layer foams accordingly, the foam layer and the thermo-sensitive layer forming the optical pattern together.

24. The method according to claim 21, wherein the disk further comprises a substrate, a pregroove formed between the substrate and the light-sensitive layer, a location where the laser light is emitted to have address information been provided through the pregroove.

25. The method according to claim 21, wherein the disk further comprises a reflection layer, the method further comprising:
transmitting the thermal energy to the reflection layer, so that the reflection layer is melted and deformed accordingly, the reflection layer and the thermo-sensitive layer forming the optical pattern together.
